(19) United States
(12) Patent Application Publication
(10) Pub. No.: US 2014/0004355 A1
(43) Pub. Date: Jan. 2, 2014

(54) MULTILAYER LIGHTWEIGHT WOODBASE MATERIALS COMPOSED OF LIGNOCELLULOSIC MATERIALS HAVING A CORE AND TWO OUTER LAYERS WITH TREATED PULP, TREATED NATURAL FIBERS, SYNTHETIC FIBERS OR MIXTURES THEREOF IN THE CORE

(71) Applicant: BASF SE, Ludwigshafen (DE)

(72) Inventors: Matthias Schade, Ludwigshafen (DE); Stephan Weinkötz, Neustadt (DE); Günter Scherr, Ludwigshafen (DE)

(73) Assignee: BASF SE, Ludwigshafen (DE)

(21) Appl. No.: 13/933,165

(22) Filed: Jul. 2, 2013

Related U.S. Application Data
(60) Provisional application No. 61/666,975, filed on Jul. 2, 2012.

(51) Int. Cl. B32B 5/26

(52) U.S. Cl. CPC B32B 5/26
USPC 428/423.3; 156/62.8

(57) ABSTRACT

The present invention relates to

lignocellulosic materials having a core and two outer layers, comprising, preferably consisting of, in the core
A) 30 to 98% by weight of lignocellulose particles,
B) 0 to 25% by weight of expanded plastics particles having a bulk density in the range from 10 to 150 kg/m³,
C) 1 to 50% by weight of one or more binders selected from the group consisting of aminoplast resin, phenol-formaldehyde resin, and organic isocyanate having at least two isocyanate groups, and
D) 0 to 10% by weight of additives
   and in the outer layers
E) 70 to 99% by weight of lignocellulosic particles, fibers or mixtures thereof,
F) 1 to 30% by weight of one or more binders selected from the group consisting of aminoplast resin, phenol-formaldehyde resin, and organic isocyanate having at least two isocyanate groups, and
G) 0 to 10% by weight of additives
   in which 2% to 30% of the lignocellulose particles A) have been replaced by treated pulps, treated natural fibers, synthetic fibers or mixtures thereof, and also relates to their production and their use.

### CROSS-REFERENCE TO RELATED APPLICATIONS

This application claims the benefit of U.S. Provisional Application 61/666,975, filed Jul. 2, 2012, which is incorporated herein by reference.

The present invention relates to lignocellulosic materials having a core and two outer layers, the core comprising treated pulps, treated natural fibers, synthetic fibers or mixtures thereof.

WO-A-2011/018373 discloses compression-molded materials which are light in weight and at the same time compressively strong, these materials consisting of woodchips or wood fibers, a binder, and a porous foamable or partly foamable plastic which acts as a filler.

The compression-molded materials comprising wood chips or wood fibers leave something to be desired in terms of their mechanical properties, such as the flexural strength or the transverse tensile.

EP-A-2 338 676 discloses lightweight construction boards having a top outer board and a bottom outer board comprising a lignocellulose-containing material, and a lightweight middle ply with honeycomb structure. In these boards, the outer boards are bonded to the middle ply using an adhesive bonding agent.

Since only the outer boards in these lightweight construction boards hold screws, these so-called honeycomb boards exhibit a substantial reduction in screw pullout resistance. Moreover, because of the honeycomb structure of the middle ply, edging can be accomplished only with extra cost in complexity and with specialty machinery.

It was an object of the present invention, therefore, to remedy the disadvantages identified above.

Found accordingly have been new, lignocellulosic materials having a core and two outer layers, comprising, preferably consisting of, in the core
A) 30 to 98% by weight of lignocellulose particles,
B) 0 to 25% by weight, preferably 1 to 25% by weight, of expanded plastics particles having a bulk density in the range from 10 to 150 kg/m³,
C) 1 to 50% by weight of one or more binders selected from the group consisting of aminoplast resin, phenol-formaldehyde resin, and organic isocyanate having at least two isocyanate groups, and
D) 0 to 10% by weight of additives
   and in the outer layers
E) 70 to 99% by weight of lignocellulosic particles, fibers or mixtures thereof,
F) 1 to 30% by weight of one or more binders selected from the group consisting of aminoplast resin, phenol-formaldehyde resin, and organic isocyanate having at least two isocyanate groups, and
G) 0 to 10% by weight of additives
   wherein 2% to 30% of the lignocellulose particles A) have been replaced by treated pulps, treated natural fibers, synthetic fibers or mixtures thereof, and also the production thereof and the use thereof.

The statement of the weight percentages of components A, B, C, D, E, F, and G relates to the dry weight of the component in question as a proportion of the overall dry weight. The sum total of the percentages by weight of components A, B, C, and D is 100% by weight. The sum total of components E, F, and G likewise makes 100% by weight. In addition, not only the outer layers but also the core comprises water, which is not taken into account in the weight figures. The water may originate from the residual moisture present in the lignocellulose particles, from the binder, from additionally added water, for dilution of the binders or for moistening of the outer layers, for example, from the additives, examples being aqueous curing agent solutions or aqueous paraffin emulsions, or from the expanded plastics particles if they are foamed, for example, using steam.

Suitable pulps are compressed and dried cellulose fibers, and suitable products, for example, are paper, paperboard, cardboard or mixtures thereof, preferably paper, paperboard or mixtures thereof, more preferably paper.

The pulps may be used in any dimensions, as for example in the form of strips, folded or bent strips, nested strips which form a lattice, sheets, sheets with cutouts, folded or bent sheets, or folded or bent sheets with cutouts; preferably strips, folded or bent strips, or nested strips which form a lattice; more preferably folded or bent strips or nested strips which form a lattice.

Suitable natural fibers include vegetable fibers such as seed fibers, for example, those of cotton or kapok, bast fibers such as bamboo fibers, jute, hemp fibers, kenaf, flax, hops, ramie or leaf fibers such as abacá pineapple, caroá, curauá, henequen, macarimba, flax, sisal or fruit fibers such as coconut or fibers of animal origin such as wool and animal hairs or silks or mixtures thereof, preferably vegetable fibers, bast fibers, leaf fibers or mixtures thereof, more preferably bast fibers, leaf fibers or mixtures thereof.

Suitable synthetic fibers include fibers of synthetic polymers such as polycondensation fibers, examples being polyester, polyamide, polyimide, polyamideimide, and polyphenylene disulfide, aramid or polyaddition fibers, as for example polyurethane, or other polymerization fibers, examples being polyacrylonitrile, polytetrafluoroethylene, polyethylene, polypropylene, and polyvinyl chloride; preferably polycondensation fibers, examples being polyester, polyamide, polyimide, polyamideimide, and polyphenylene disulfide, aramid, or other polymerization fibers, as for example polyacrylonitrile, polytetrafluoroethylene, polyethylene, polypropylene, and polyvinyl chloride; more preferably polycondensation fibers, examples being polyesters, polyamide, polyimide, polyamideimide, and polyphenylene disulfide, and aramid.

The natural fibers or synthetic fibers may be used in any length and any diameter or in a form in which they have been spun/linked to form ropes, cords or tapes, preferably as cords or tapes, more preferably as cords.

The pulps, natural fibers and/or synthetic fibers may be impregnated or sprayed in a conventional way with aminoplast resins, phenol-formaldehyde resin, organic isocyanate having at least two isocyanate groups, or mixtures thereof. The amounts applied to the pulps, natural fibers and/or synthetic fibers may vary within wide limits and are situated generally in a weight ratio of aminoplast resin, phenol-formaldehyde resin, organic isocyanate having at least two isocyanate groups, or mixtures thereof to the pulp or to the natural fiber of 0.5:1 to 5:1, preferably 0.75:1 to 4:1, more preferably 1:1 to 3:1.

After the spraying or impregnation, the treated pulps, natural fibers or synthetic fibers may be subjected to drying and/or preliminary curing.

In the lignocellulosic materials of the invention, generally 2% to 30% by weight, preferably 3% to 20% by weight, especially 4% to 15% by weight of the lignocellulose particles A) have been replaced by treated pulps, treated natural fibers, synthetic fibers or mixtures thereof.

The lignocellulosic materials (lignocellulose materials) of the invention can be produced as follows:

The components for the core and the components for the outer layers are generally mixed separately from one another.

For the core, the lignocellulose particles A may be mixed with the components B, C and D and/or with the component constituents comprised therein (i.e., a plurality of constituents, such as substances or compounds, for example, from the group of one component) in any desired order. Components A, B, C and D may in each case be composed of one, two (A1, A2 or B1, B2, or C1, C2 or D1, D2) or a plurality of component constituents (A1, A2, A3, . . . , or B1, B2, B3, . . . , C1, C2, C3, . . . , or D1, D2, D3, . . . ).

Where the components consist of a plurality of component constituents, these component constituents may be added either as a mixture or separately from one another. In the case of separate addition, these component constituents may be added directly after one another or else at different points in time not following directly on from one another. In the event, for example, that component C is composed of two constituents C1 and C2, this means that C2 is added immediately after C1 or C1 is added immediately after C2, or that one or more other components or component constituents, component B for example, are added between the addition of C1 and C2. It is also possible for components and/or component constituents to be premixed with other components or component constituents before being added. For example, an additive constituent D1 may be added to the binder C or to the binder constituent C1 before this mixture is then added to the actual mixture.

Preferably, first of all, the expanded plastics particles B are added to the lignocellulose particles A, and this mixture is thereafter admixed with a binder C or with two or more binder constituents C1, C2, etc. Where two or more binder constituents are used, they are preferably added separately from one another. The additives D are preferably partially mixed with the binder C or with a binder constituent (i.e., a plurality of constituents, such as substances or compounds, for example, from the group of the component) and then added.

For the outer layers, the lignocellulosic particles or fibers E are mixed with the components F and G and/or with the component constituents present therein (i.e., a plurality of constituents, such as substances or compounds, for example, from the group of one component) in any desired order. For the two outer layers it is possible to use either the same mixture or two different mixtures, preferably the same mixture.

Where the components consist of a plurality of component constituents, these constituents can be added either as a mixture or separately from one another. In that case, these component constituents can be added directly after one another or else at different points in time not following directly on from one another. The additives G are preferably partially mixed with the binder F or a binder constituent and then added.

The resulting mixtures A, B, C, D and E, F, G are layered one atop another, the pulps, natural fibers, synthetic fibers or mixtures thereof are incorporated into the middle layer, and this system is compressed by a customary process, at elevated temperature, to give a lignocellulosic molding.

For this purpose, first of all half of the mixture E, F, G is scattered on a support. Thereafter, some of the mixture A, B, C, D is applied as a layer over it, and the pulps, natural fibers or synthetic fibers are pressed gently into this mixture. These pulps, natural fibers or synthetic fibers are arranged parallel to one another at a distance of 1-2 cm, overlaying one another to form a lattice, in spiral format, or unordered, preferably parallel at a distance of 1-2 cm or overlaying one another to form a lattice, more preferably overlaying one another to form a lattice. Now the remaining A, B, C, D mixture, followed by the E, F, G mixture, are applied in layers over the pulps or natural or synthetic fibers (“sandwich construction”).

This mat is compressed customarily at temperatures from 80 to 300° C., preferably 120 to 280° C., more preferably 150 to 250° C., and at pressures from 1 to 50 bar, preferably 3 to 40 bar, more preferably 5 to 30 bar, to form moldings. In one preferred embodiment, the mat is subjected to cold precompaction ahead of this hotpressing. Compression may take place by any of the methods known to the skilled person (see examples in “Taschenbuch der Spanplatten Technik”, H.-J. Deppe, K. Ernst, 4th edn., 2000, DRW—Verlag Weinbrenner, Leinfelden Echterdingen, pages 232 to 254, and “MDF—Mitteldichte Faserplatten” H.-J. Deppe, K. Ernst, 1996, DRW—Verlag Weinbrenner, Leinfelden-Echterdingen, pages 93 to 104). These methods use discontinuous pressing techniques, on single-stage or multistage presses, for example, or continuous pressing techniques, on double-belt presses, for example.

The lignocellulose materials of the invention generally have an average density of 300 to 600 kg/m³, preferably 350 to 590 kg/m³, more preferably 400 to 570 kg/m³, more particularly 450 to 550 kg/m³.

The lignocellulose particles of component A are present in the lignocellulosic materials of the core in amounts from 30% to 98% by weight, preferably 50% to 95% by weight, more preferably 70% to 90% by weight, and their base material is any desired wood variety or mixtures thereof, examples being spruce, beech, pine, larch, lime, poplar, ash, chestnut and fir wood or mixtures thereof, preferably spruce, beech or mixtures thereof, more particularly spruce, and may comprise, for example, wood parts such as wood laths, wood strips, wood chips, wood fibers, wood dust or mixtures thereof, preferably wood chips, wood fibers, wood dust and mixtures thereof, more preferably wood chips, wood fibers or mixtures thereof—like those used for producing chipboard, MDF (medium-density fiberboard) and HDF (high-density fiberboard) panels. The lignocellulose particles may also come from woody plants such as flax, hemp, cereals or other annual plants, preferably from flax or hemp shives or mixtures thereof, more preferably flax or hemp fibers or mixtures thereof, like those used in manufacturing MDF and HDF boards.

Starting materials for lignocellulose particles are customarily lumber from forestry thinning, residual industrial lumber, and used lumber, and also woody plants. Processing to the desired lignocellulosic particles, to wood particles for example, may take place in accordance with known methods (e.g., M. Dunky, P. Niemz, Holzwerkstoffe und Leime, pages 91 to 156, Springer Verlag Heidelberg, 2002).

After the chipping of the wood, the chips are dried. Then any coarse and fine fractions are removed. The remaining chips are sorted by sieving or classifying in a stream of air. The coarser material is used for the middle layer (component A), the finer material for the outer layers (component E).

The lignocellulosic fibers of component E are present within the lignocellulosic materials of the outer layer in amounts of 70 to 99% by weight, preferably 75 to 97% by weight, more preferably 80 to 95% by weight. Raw materials which can be used are woods of any of the wood varieties listed under component A, or woody plants. Following mechanical comminution, the fibers may be produced by grinding operations, for example, after a hydrothermal pretreatment. Fiberizing methods are known from, for example, Dunky, Niemz, Holzwerkstoffe and Leime, Technologie und Einflussfaktoren, Springer, 2002, pages 135 to 148.

Suitable expanded plastics particles (component B) include expanded plastics particles, preferably expanded thermoplastic particles, having a bulk density from 10 to 150 kg/m³, preferably 30 to 130 kg/m³, more preferably 35 to 110 kg/m³, more particularly 40 to 100 kg/m³ (determined by weighing a defined volume filled with the bulk material).

Expanded plastics particles B are used generally in the form of spheres or beads having an average diameter of 0.01 to 50 mm, preferably 0.25 to 10 mm, more preferably 0.4 to 8.5 mm, more particularly 0.4 to 7 mm. In one preferred embodiment the spheres have a small surface area per unit volume, in the form of a spherical or elliptical particle, for example, and advantageously are closed-cell spheres. The open-cell proportion according to DIN ISO 4590 is generally not more than 30%, i.e., 0% to 30%, preferably 1% to 25%, more preferably 5% to 15%.

Suitable polymers on which the expandable or expanded plastics particles are based are generally all known polymers or mixtures thereof, preferably thermoplastic polymers or mixtures thereof, which can be foamed. Examples of highly suitable such polymers include polyketones, polysulfones, polyoxymethylene, PVC (rigid and flexible), polycarbonates, polyisocyanurates, polycarbodiimides, polyacrylimides and polymethacrylimides, polyamides, polyurethanes, aminoplast resins and phenolic resins, styrene homopolymers (also referred to below as “polystyrene” or “styrene polymer”), styrene copolymers, C₂-C₁₀ olefin homopolymers, C₂-C₁₀ olefin copolymers, and polyesters. For producing the stated olefin polymers it is preferred to use the 1-alkenes, examples being ethylene, propylene, 1-butene, 1-hexene and 1-octene. Customary additives may additionally be admixed with the polymers, preferably the thermoplastics, forming a basis for the expandable or expanded plastics particles B), examples of such additives being UV stabilizers, antioxidants, coating materials, hydrophobing agents, nucleators, plasticizers, flame retardants, soluble and insoluble, organic and/or inorganic dyes, pigments, and athermanous particles, such as carbon black, graphite or aluminum powder, together or spatially separately, as adjuvants.

Component B may customarily be obtained as follows:

Suitable polymers, using an expansion-capable medium (also called “blowing agent”) or comprising an expansion-capable medium, can be expanded by exposure to microwave energy, thermal energy, hot air, preferably steam, and/or a change in pressure (this expansion often also being referred to as “foaming”) (Kunststoff Handbuch 1996, volume 4, “Polystyrol”, Hanser 1996, pages 640 to 673 or U.S. Pat. No. 5,112,875). In the course of this procedure, generally, the blowing agent expands, the particles increase in size, and cell structures are formed. This expanding can be carried out in customary foaming apparatus, often referred to as “prefoamers”. Such prefoamers may be installed permanently or else may be portable. Expanding can be carried out in one or more stages. In the one-stage process, in general, the expandable plastics particles are expanded directly to the desired final size. In the multistage process, in general, the expandable plastics particles are first expanded to an intermediate size and then, in one or more further stages, are expanded via a corresponding number of intermediate sizes to the desired final size. The compact plastics particles identified above, also referred to herein as “expandable plastics particles”, generally have no cell structures, in contrast to the expanded plastics particles. The expanded plastics particles generally have only a low residual blowing agent content, of 0% to 5% by weight, preferably 0.5% to 4% by weight, more preferably 1% to 3% by weight, based on the overall mass of plastic and blowing agent. The expanded plastics particles obtained in this way can be placed in interim storage or used further without other intermediate steps for producing component B of the invention.

The expandable plastics particles can be expanded using all of the blowing agents known to the skilled person, examples being aliphatic C₃ to C₁₀ hydrocarbons, such as propane, n-butane, isobutane, n-pentane, isopentane, neopentane, cyclopentane and/or hexane and isomers thereof, alcohols, ketones, esters, ethers or halogenated hydrocarbons, preferably n-pentane, isopentane, neopentane and cyclopentane, more preferably a commercial pentane isomer mixture of n-pentane and isopentane.

The amount of blowing agent in the expandable plastics particles is generally in the range from 0.01% to 7% by weight, preferably 0.01% to 4% by weight, more preferably 0.1% to 4% by weight, based in each case on the expandable plastics particles containing blowing agent.

One preferred embodiment uses styrene homopolymer (also called simply “polystyrene” herein), styrene copolymer or mixtures thereof as the sole plastic in component B.

Polystyrene and/or styrene copolymer of this kind may be prepared by any of the polymerization techniques known to the skilled person; see, for example, Ullmann's Encyclopedia, Sixth Edition, 2000 Electronic Release or Kunststoff-Handbuch 1996, volume 4 “Polystyrol”, pages 567 to 598.

The expandable polystyrene and/or styrene copolymer is/are generally prepared in a conventional way by suspension polymerization or by means of extrusion processes.

The overall amount of the expanded plastics particles B, based on the overall dry mass of the core, is generally in the range from 0% to 25% by weight, preferably 1% to 25% by weight, more preferably 3% to 20% by weight, more particularly 5% to 15% by weight.

The overall amount of the binder C, based on the overall mass of the core, is in the range from 1% to 50% by weight, preferably 2% to 15% by weight, more preferably 3% to 10% by weight.

The overall amount of the binder F, based on the overall dry mass of the outer layer(s), is in the range from 1% to 30% by weight, preferably 2% to 20% by weight, more preferably 3% to 15% by weight.

The binders of component C and of component F may be selected from the group consisting of amino-plast resin, phenol-formaldehyde resin, and organic isocyanate having at least two isocyanate groups, using identical or different binders or binder mixtures of components C and F, preferably identical binders, with particular preference aminoplast in both cases. The weight figure in the case of aminoplasts or phenol-formaldehyde resins relates to the solids content of the corresponding component (determined by evaporating the water at 120° C. over the course of 2 hours in accordance with Günter Zeppenfeld, Dirk Grunwald, Klebstoffe in der Holz- and Möbelindustrie, 2^{nd} edition, DRW-Verlag, page 268), while in relation to the isocyanate, more particularly the PMDI (polymeric diphenylmethane diisocyanate), it relates to the isocyanate component per se, in other words, for example, without solvent or emulsifying medium.

As aminoplast resin it is possible to use all aminoplast resins known to the skilled person, preferably those known for the production of woodbase materials. Resins of this kind and also their preparation are described in, for example, Ullmanns Enzyklopädie der technischen Chemie, 4th, revised and expanded edition, Verlag Chemie, 1973, pages 403 to 424 “Aminoplaste”, and Ullmann's Encyclopedia of Industrial Chemistry, vol. A2, VCH Verlagsgesellschaft, 1985, pages 115 to 141 “Amino Resins”, and also in M. Dunky, P. Niemz, Holzwerkstoffe und Leime, Springer 2002, pages 251 to 259 (UF resins) and pages 303 to 313 (MUF and UF with a small amount of melamine). Generally speaking, they are polycondensation products of compounds having at least one—optionally substituted partially with organic radicals—amino group or carbamide group (the carbamide group is also called carboxamide group), preferably carbamide group, preferably urea or melamine, and an aldehyde, preferably formaldehyde. Preferred polycondensation products are urea-formaldehyde resins (UF resins), melamine-formaldehyde resins (MF resins) or melamine-containing urea-formaldehyde resins (MUF resins), more preferably urea-formaldehyde resins, examples being Kaurit® glue products from BASF SE.

Particularly preferred polycondensation products are those in which the molar ratio of aldehyde to the—optionally substituted partially with organic radicals—amino group and/or carbamide group is in the range from 0.3:1 to 1:1, preferably 0.3:1 to 0.6:1, more preferably 0.3:1 to 0.55:1, very preferably 0.3:1 to 0.5:1. Where the aminoplasts are used in combination with isocyanates, the molar ratio of aldehyde to the—optionally substituted partially with organic radicals—amino group and/or carbamide group is in the range from 0.3:1 to 1:1, preferably 0.3:1 to 0.6:1, more preferably 0.3:1 to 0.45:1, very preferably 0.3:1 to 0.4:1.

Phenol-formaldehyde resins (also called PF resins) are known from, for example, Kunststoff-Handbuch, 2^{nd} edition, Hanser 1988, volume 10, “Duroplaste”, pages 12 to 40.

The stated aminoplast resins are used customarily in liquid form, usually in solution, customarily as a 25% to 90% by weight strength solution, preferably as a 50% to 70% by weight strength solution, preferably in aqueous solution, but may also be used in solid form.

The solids content of the liquid aqueous aminoplast resin can be determined in accordance with Günter Zeppenfeld, Dirk Grunwald, Klebstoffe in der Holz-und Möbelindustrie, 2^{nd} edition, DRW-Verlag, page 268.

The constituents of the binder C and of the binder F can be used per se alone—that is, for example, aminoplast resin or organic isocyanate or PF resin as sole constituent of binder C or of binder F. However, the resin constituents of binder C and of binder F may also be used as a combination of two or more constituents of the binder C and/or of the binder F; these combinations preferably comprise an aminoplast resin and/or phenol-formaldehyde resin.

In one preferred embodiment a combination of aminoplast and isocyanate can be used as binder C. In this case, the total amount of the aminoplast resin in the binder C, based on the overall dry mass of the core, is in the range from 1% to 45% by weight, preferably 4% to 14% by weight, more preferably 6% to 9% by weight. The overall amount of the organic isocyanate, preferably of the oligomeric isocyanate having 2 to 10, preferably 2 to 8 monomer units and on average at least one isocyanate group per monomer unit, more preferably PMDI, in the binder C, based on the overall dry mass of the core, is in the range from 0.05% to 5% by weight, preferably 0.1% to 3.5% by weight, more preferably 0.5% to 1.5% by weight.

Components D and G may each independently of one another comprise different or identical, preferably identical curing agents that are known to the skilled person, or mixtures thereof. These components are customarily used if the binder C and/or F comprises aminoplasts or phenol-formaldehyde resins. These curing agents are preferably added to the binder C and/or F, in the range, for example, from 0.01% to 10% by weight, preferably 0.05% to 5% by weight, more preferably 0.1% to 3% by weight, based on the overall amount of aminoplast resin or phenol-formaldehyde resin.

Curing agents for the aminoplast resin component or for the phenol-formaldehyde resin component are understood herein to encompass all chemical compounds of any molecular weight that accelerate or bring about the polycondensation of aminoplast resin or phenol-formaldehyde resin. One highly suitable group of curing agents for aminoplast resin or phenol-formaldehyde resin are organic acids, inorganic acids, acidic salts of organic acids, and acidic salts of inorganic acids, such as ammonium salts or acidic salts of organic amines. The components of this group can of course also be used in mixtures. Examples are ammonium sulfate or ammonium nitrate or organic or inorganic acids, as for example sulfuric acid, formic acid or acid-regenerating substances, such as aluminum chloride, aluminum sulfate or mixtures thereof. One preferred group of curing agents for aminoplast resin or phenol-formaldehyde resin are organic or inorganic acids such as nitric acid, sulfuric acid, formic acid, acetic acid, and polymers with acid groups, such as homopolymers or copolymers of acrylic acid or methacrylic acid or maleic acid.

Phenol-formaldehyde resins can also be cured alkalinically. It is preferred to use carbonates or hydroxides such as potassium carbonate and sodium hydroxide.

Further examples of curing agents for aminoplast resins are known from M. Dunky, P. Niemz, Holzwerkstoffe und Leime, Springer 2002, pages 265 to 269, and further examples of curing agents for phenol-formaldehyde resins are known from M. Dunky, P. Niemz, Holzwerkstoffe und Leime, Springer 2002, pages 341 to 352.

The lignocellulose materials of the invention may comprise further commercially customary additives and additives known to the skilled person, as component D and as component G, independently of one another identical or different, preferably identical additives, in amounts from 0% to 10% by weight, preferably 0.5% to 5% by weight, more preferably 1% to 3% by weight, examples being hydrophobizing agents such as paraffin emulsions, antifungal agents, formaldehyde scavengers, such as urea or polyamines, for example, and flame retardants.

The thickness of the lignocellulose materials of the invention varies with the field of application and is situated in general in the range from 0.5 to 100 mm, preferably in the range from 10 to 40 mm, more particularly 15 to 20 mm.

Lignocellulose materials, as for example woodbase materials, are an inexpensive and resource-protecting alternative to solid wood, and have become very important particularly in furniture construction, for laminate floors and as construction materials. Customarily serving as starting materials are wood particles of different thicknesses, examples being wood chips or wood fibers from a variety of woods. Such wood particles are customarily compressed with natural and/or synthetic binders and optionally with addition of further additives to form woodbase materials in panel or strand forms.

Lightweight woodbase materials are very important for the following reasons: Lightweight woodbase materials lead to greater ease of handling of the products by the end customers, as for example when packing, transporting, unpacking or constructing the furniture. Lightweight woodbase materials result in lower costs for transport and packaging, and it is also possible to save on materials costs when producing lightweight woodbase materials. Lightweight woodbase materials may, when used in means of transport, for example, result in a lower energy consumption by those means of transport. Furthermore, using lightweight woodbase materials, it is possible to carry out more cost-effective production of, for example, material-intensive decorative parts, relatively thick worktops and side panels in kitchens.

There are numerous applications, as for example in the bathroom or kitchen furniture segment or in interior outfitting, where lightweight and economic lignocellulosic materials having improved mechanical properties, as for example improved flexural strengths, are sought after. Moreover, such materials are to have an extremely good surface quality, in order to allow application of coatings, for example a paint or varnish finish, having good properties.

### EXAMPLES

### Production of the Boards

### Production of the Mixtures (A, B, C, D), (E, F, G) and Also of the Impregnated Pulps and Natural Fibers/Synthetic Fibers

The glue used was urea-formaldehyde glue (Kaurit® glue 347 from BASF SE). The solids content was adjusted with water in each case to 67% by weight. Details are evident from the table.

### Production of a Mixture A, B, C, D:

In a mixer, 330 g of chips (component A) and 33 g of expanded polymer (component B) were mixed as per the table. Then 62.7 g of a glue liquor comprising 100 parts of Kaurit® glue 347 and 4 parts of a 52% strength aqueous ammonium nitrate solution, 1.3 parts of urea, and 0.8 part of a 60% aqueous paraffin dispersion were applied.

### Production of a Mixture E, F, G:

Furthermore, in a mixer, 179.6 g of chips or fibers (component E) as per the table were applied with 30.4 g of a glue liquor comprising 100 parts of Kaurit® glue 347 and 1 part of a 52% strength aqueous ammonium nitrate solution, 0.5 part of urea, 0.5 part of a 60% aqueous paraffin dispersion, and 40 parts of water.

### Production of the Impregnated Paper Strips:

Standard commercial paper (200 g/m²) was cut into strips measuring 1.3×30 cm long and impregnated twice in an impregnating bath with melamine-formaldehyde impregnating resin, consisting of 100 parts of Kauramin® impregnating resin 783, 7.1 parts of water, 0.35 part of Kauropal® 930, and 0.3 part of Härter 529 curing agent, drawn through two coating bars, and dried.

### Compressing of the Glue-Treated Chips

The glue-treated chips were filled into a 30×30 cm mold as follows:

First of all, half of mixture (E, F, G) was scattered into the mold. Then 15% to 50% of the mixture (A, B, C, D) was applied as a layer over it. Pressed subsequently into this cake of chips were the reinforcing elements (paper, cord, rope; see table), in the geometry indicated in the table, and the remainder of the mixture (A, B, C, D) was scattered over this. Finally, the second half of the mixture (E, F, G) was applied as a layer over this, and subjected to cold precompaction. This was followed by pressing in a hot press (pressing temperature 210° C., pressing time 120 s). The target thickness of each board was 16 mm.

Investigation of the Lightweight, Wood-Containing Substance

Density:

The density was determined 24 hours after production. For this purpose, the ratio of mass to volume of a test specimen was determined at the same moisture content. The square test specimens have a side length of 50 mm, with an accuracy of 0.1 mm. The thickness of the test specimen was measured in its center, to an accuracy of 0.05 mm. The accuracy of the balance used for determining the mass of the test specimen was 0.01 g. The gross density ρ (kg/m³) of a test specimen was calculated by the following formula:

ρ=m/(b₁*b₂*d)*10⁶

### Here:

m is the mass of the test specimen, in grams, and
b₁, b₂, and d are the width and thickness of the test specimen, in millimeters.

A precise description of the procedure can be found in DIN EN 323, for example.

### Transverse Tensile Strength:

The transverse tensile strength is determined perpendicular to the board plane. For this purpose, the test specimen was loaded to fracture with a uniformly distributed tensile force. The square test specimens had a side length of 50 mm, with an accuracy of 1 mm, and angles of exactly 90°. Moreover, the edges were clean and straight. The test specimens were bonded to the yokes by means of a suitable adhesive, an epoxy resin, for example, and dried for at least 24 hours in a controlled-climate cabinet at 20° C. and 65% atmospheric humidity. The test specimen prepared in this way was then clamped into the testing machine in a self-aligning manner with a shaft joint on both sides, and then loaded to fracture at a constant rate, with the force needed to achieve this being recorded. The transverse tensile strength fₜ (N/mm²) was calculated by the following formula:

fₜ=Fₘₐₓ/(a*b)

### Here:

Fₘₐₓ is the breaking force in newtons
a and b are the length and width of the test specimen, in millimeters.

A precise description of the procedure can be found in DIN EN 319, for example.

### Flexural Strength

The flexural strength was determined by applying a load in the middle of a test specimen lying on two points. The test specimen had a width of 50 mm and a length of 20 times the nominal thickness plus 50 mm, but not more than 1050 mm and not less than 150 mm. The test specimen was then placed flatly onto two bearing mounts, the inter-center distance of which was 20 times the thickness of the test specimen, and the test specimen was then loaded to fracture in the middle with a force, this force being recorded. The flexural strength fₘ (N/mm²) was calculated by the following formula:

fₘ=(3*Fₘₐₓ*I)/(2*b*t²)

### Here:

Fₘₐₓ is the breaking force in newtons
I is the distance between the centers of the bearing mounts, in millimeters
b is the width of the test specimen, in millimeters
t is the thickness of the test specimen, in millimeters.

A precise description of the procedure can be found in DIN EN 310.

### Screw Pullout Resistance

The screw pullout resistance was determined by measuring the force needed to pull out a screw in an axially parallel fashion from the test specimen. The square test specimens had a side length of 75 mm, with an accuracy of 1 mm. First of all, guide holes with a diameter of 2.7 mm (±0.1 mm), and depth of 19 (±1 mm) were drilled perpendicular to the surface of the test specimen into the central point of the surface. Subsequently, for the test, a steel screw with nominal dimensions of 4.2 mm×38 mm, having a ST 4.2 thread in accordance with ISO 1478 and a pitch of 1.4 mm, was inserted into the test specimen, with 15 mm (±0.5 mm) of the whole screw being inserted. The test specimen was fixed in a metal frame and, via a stirrup, a force was applied to the underside of the screw head, the maximum force with which the screw was pulled out being recorded.

A precise description of the procedure can be found in DIN EN 320.

The results of the tests are summarized in the table.

The quantity figures are based in each case on the dry substance. When parts by weight are stated, the dry wood or the sum of the dry wood and the filler was taken as 100 parts. When % by weight is stated, the sum of all the dry constituents of the lightweight, wood-containing material is 100%.

The tests in the table without addition of component reinforcements serve as a comparison and were carried out in accordance with WO-A-2011/018373.

| | | | Component B | | Paper | |
|---|---|---|---|---|---|---|
| | Target density | Component A | (expanded | | density | |
| Test | [kg/m³] | (wood) [g] | polymer) [g] | UF glue [g] | [g/m²] | Paper geometry |
| 1 | 400 | 330 | 33 | 63 | 75 | Bent strips |
| 2 | 450 | 368 | 37 | 70 | 75 | arranged in |
| 3 | 500 | 393 | 39 | 75 | 75 | parallel |
| 4 | 400 | 330 | 33 | 63 | 120 | Bent strips |
| 5 | 450 | 368 | 37 | 70 | 120 | arranged in |
| 6 | 500 | 393 | 39 | 75 | 120 | parallel |
| 7 | 400 | 330 | 33 | 63 | 200 | Bent strips |
| 8 | 450 | 368 | 37 | 70 | 200 | arranged in |
| 9 | 500 | 393 | 39 | 75 | 200 | parallel |
| 10 | 400 | 330 | 33 | 63 | 120 | Arranged in a |
| 11 | 450 | 368 | 37 | 70 | 120 | lattice |
| 12 | 500 | 393 | 39 | 75 | 120 | |
| 13 | 400 | 330 | 33 | 63 | 200 | Arranged in a |
| 14 | 450 | 368 | 37 | 70 | 200 | lattice |
| 15 | 500 | 393 | 39 | 75 | 200 | |
| 16^{[1]} | 400 | 330 | 33 | 63 | — | — |
| 17^{[1]} | 450 | 368 | 37 | 70 | — | — |
| 18^{[1]} | 500 | 393 | 39 | 75 | — | — |

| | Density | Transverse tensile | Flexural strength | Screw pullout resistance |
|---|---|---|---|---|
| Test | [kg/m³] | strength [N/mm²] | [N/mm²] | [N] |
| 1 | 428 | 0.56 | 9.83 | 335 |
| 2 | 462 | 0.67 | 13.27 | 387 |
| 3 | 502 | 0.77 | 15.22 | 523 |
| 4 | 436 | 0.60 | 10.98 | 350 |
| 5 | 486 | 0.73 | 14.85 | 410 |
| 6 | 513 | 0.83 | 17.42 | 547 |
| 7 | 456 | 0.76 | 11.67 | 371 |
| 8 | 504 | 0.81 | 14.82 | 510 |
| 9 | 530 | 0.92 | 18.21 | 632 |
| 10 | 446 | 0.64 | 11.67 | 363 |
| 11 | 491 | 0.74 | 14.46 | 481 |
| 12 | 528 | 0.82 | 17.39 | 554 |
| 13 | 474 | 0.82 | 11.88 | 495 |
| 14 | 512 | 0.91 | 15.66 | 593 |
| 15 | 543 | 0.95 | 18.52 | 578 |
| 16^{[1]} | 417 | 0.42 | 8.23 | 262 |
| 17^{[1]} | 465 | 0.42 | 11.11 | 340 |
| 18^{[1]} | 493 | 0.58 | 14.43 | 418 |

^{[1]}= Comparative test as per the sole example in WO-A-2011/018373

1.-16. (canceled)

17. A lignocellulosic material having a core and two outer layers, comprising in the core
A) 30 to 98% by weight of lignocellulose particles,
B) 0 to 25% by weight of expanded plastics particles having a bulk density in the range from 10 to 150 kg/m³,
C) 1 to 50% by weight of one or more binders selected from the group consisting of aminoplast resin, phenol-formaldehyde resin, and organic isocyanate having at least two isocyanate groups, and
D) 0 to 10% by weight of additives
and in the outer layers
E) 70 to 99% by weight of lignocellulosic particles, fibers or mixtures thereof,
F) 1 to 30% by weight of one or more binders selected from the group consisting of aminoplast resin, phenol-formaldehyde resin, and organic isocyanate having at least two isocyanate groups, and
G) 0 to 10% by weight of additives
in which 2% to 30% of the lignocellulose particles A) have been replaced by treated pulps, treated natural fibers, synthetic fibers or mixtures thereof.

18. The lignocellulosic material having a core and two outer layers according to claim 17, comprising in the core
B) 1 to 25% by weight of expanded plastics particles having a bulk density in the range from 10 to 150 kg/m³.

19. The lignocellulosic material having a core and two outer layers according to claim 17, wherein 3% to 20% of the lignocellulose particles A) have been replaced by treated pulps, treated natural fibers, synthetic fibers or mixtures thereof.

20. The lignocellulosic material having a core and two outer layers according to claim 17, wherein 4% to 15% of the lignocellulose particles A) have been replaced by treated pulps, treated natural fibers, synthetic fibers or mixtures thereof.

21. The lignocellulosic material having a core and two outer layers according to claim 17, wherein said pulps comprise compressed and dried cellulose fibers.

22. The lignocellulosic material having a core and two outer layers according to claim 17, wherein said pulps comprise paper, paperboard, cardboard or mixtures thereof.

23. The lignocellulosic material having a core and two outer layers according to claim 17, wherein said pulps comprise paper, paperboard, or mixtures thereof.

24. The lignocellulosic material having a core and two outer layers according to claim 17, wherein said natural fibers comprise vegetable fibers.

25. The lignocellulosic material having a core and two outer layers according to claim 17, wherein said natural fibers comprise seed fibers, bast fibers, leaf fibers, fruit fibers, fibers of animal origin or mixtures thereof.

26. The lignocellulosic material having a core and two outer layers according to claim 17, wherein said synthetic fibers suitably comprise fibers of synthetic polymers.

27. A method for producing a lignocellulosic material according to claim 17, which comprises mixing the components for the core A to D as middle layer and the outer layers E to G separately from one another, applying the resulting mixtures in layers one above another, introducing the pulps, natural fibers, synthetic fibers or mixtures thereof into the middle layer, and compressing this system at temperatures from 80 to 300° C. under a pressure of 1 to 50 bar to form moldings.

28. The method for producing a lignocellulosic material according to claim 17, which comprises mixing the components for the core A to D as middle layer and the outer layers E to G separately from one another, applying the resulting mixtures in layers one above another, introducing the pulps, natural fibers, synthetic fibers or mixtures thereof into the middle layer, and compressing this system at temperatures from 120 to 280° C. under a pressure of 1 to 50 bar to form moldings.

29. The method for producing a lignocellulosic material according to claim 17, which comprises mixing the components for the core A to D as middle layer and the outer layers E to G separately from one another, applying the resulting mixtures in layers one above another, introducing the pulps, natural fibers, synthetic fibers or mixtures thereof into the middle layer, and compressing this system at temperatures from 80 to 300° C. under a pressure of 3 to 40 bar to form moldings.

30. The method for producing a lignocellulosic material according to claim 17, which comprises mixing the components for the core A to D as middle layer and the outer layers E to G separately from one another, applying the resulting mixtures in layers one above another, introducing the pulps, natural fibers, synthetic fibers or mixtures thereof into the middle layer, and compressing this system at temperatures from 120 to 280° C. under a pressure of 3 to 40 bar to form moldings.

31. Use of the lignocellulosic material according to claim 17 for producing articles of all kinds and in the construction sector.

32. The use of the lignocellulosic material according to claim 17 for producing furniture and furniture parts, packing materials, in home construction or in interior outfitting.
